(19) United States
(12) Patent Application Publication
(10) Pub. No.: US 2021/0200816 A1
(43) Pub. Date: Jul. 1, 2021

(54) DOCUMENT MANAGEMENT APPARATUS AND NON-TRANSITORY COMPUTER READABLE MEDIUM STORING DOCUMENT MANAGEMENT PROGRAM

(71) Applicant: FUJI XEROX CO., LTD., Tokyo (JP)

(72) Inventors: Junko MURAKAMI, Kanagawa (JP); Yasuhiro ITO, Kanagawa (JP); Tomoyuki SHIMIZU, Kanagawa (JP); Tadanobu MIYAUCHI, Kanagawa (JP)

(73) Assignee: FUJI XEROX CO., LTD., Tokyo (JP)

(21) Appl. No.: 16/892,294

(22) Filed: Jun. 4, 2020

(30) Foreign Application Priority Data
Dec. 27, 2019 (JP) 2019-238647

(51) Int. Cl. G06F 16/903; G06F 16/93; G06F 16/16

(52) U.S. Cl. CPC G06F 16/90344; G06F 16/164; G06F 16/93

(57) ABSTRACT

A document management apparatus includes a processor configured to acquire a document name of a document including a designated string; in a case where the acquired document name is configured according to a naming rule used for automatic generation of a document name, specify meaning of a component including the designated text string, constituting the document name of the document, as supplementary information of the document name of the document, by using the naming rule; and output the document name of the document such that the meaning of the specified supplementary information is to be understood.

### CROSS-REFERENCE TO RELATED APPLICATIONS

This application is based on and claims priority under 35 USC 119 from Japanese Patent Application No. 2019-238647 filed Dec. 27, 2019.

### BACKGROUND

### (i) Technical Field

The present invention relates to a document management apparatus and a non-transitory computer readable medium storing a document management program.

### (ii) Related Art

JP2017-162181A discloses an image processing apparatus including a determination unit that determines whether or not each of a plurality of scan documents is an automatically-named document that is a scan document of which document name is automatically assigned, a search unit that searches for documents to be listed which are scan documents to be listed on the display unit of the image processing apparatus, from the plurality of scan documents, and a display control unit that lists the searched documents to be listed on the display unit, in which the search unit excludes the scan documents which are determined to be the automatically-named documents among the plurality of scan documents, from the documents to be listed.

JP2015-106354A discloses a search suggestion apparatus which is connected via a network to a search server and a user terminal that transmits a search query to the search server and performs a search, the search suggestion apparatus includes a suggestion dictionary storage unit that arranges and stores search query candidates in a predetermined order, a query receiving unit that receives the input search query and user attributes from the user terminal, a suggestion extraction unit that extracts the search query candidates including the search query, from the suggestion dictionary storage unit, a suggestion selection unit that selects the search query candidates, based on the user attribute, from the extracted search query candidates, and a suggestion sending unit that sends the selected search query candidates to the user terminal.

### SUMMARY

In order to find the target document from a plurality of documents, there is a technique of searching for documents that include the designated text string in the document name, inferring the contents of the document from the document name of the searched document, and determining whether or not the target document is included in the searched document.

In a case where the document name includes a meaningful text string representing the contents of the document, it is easy to interfere the contents of the document, but in some cases, there is a document having a document name from which it is difficult to understand the meaning at first glance, such as a string of at least one of numbers, texts, or symbols. In particular, in the case where a document obtained by automatically assigning the document name to the received facsimile data and filing this data by a facsimile machine, for example, is included in the search target, a document name from which it is difficult to understand the meaning at first glance may be included in the search result.

Therefore, in a case of displaying the document name of a searched document, by only simply highlighting a text string that matches the designated text in boldface, it may be difficult to determine whether or not the document represented by the document name is the target document.

Aspects of non-limiting embodiments of the present disclosure relate to a document management apparatus and a non-transitory computer readable medium storing a document management program, that are capable of searching for a document that includes a text string designated by a search condition in a document name from a document to which a document name is automatically assigned, and making it easier for the user to determine whether or not the document is the target document, as compared to a case where in the document name of the searched document, a part matching the designated text string is simply highlighted and displayed.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

A document management apparatus includes a processor configured to acquire a document name of a document including a designated string; in a case where the acquired document name is configured according to a naming rule used for automatic generation of a document name, specify meaning of a component including the designated text string, constituting the document name of the document, as supplementary information of the document name of the document, by using the naming rule; and output the document name of the document such that the meaning of the specified supplementary information is to be understood.

### BRIEF DESCRIPTION OF THE DRAWINGS

Exemplary embodiment(s) of the present invention will be described in detail based on the following figures, wherein:

FIG. 1 is a diagram illustrating a configuration example of a document management system;

FIG. 2 is a diagram illustrating an example of a functional configuration of each of a user terminal and a server;

FIG. 3 is a diagram illustrating an example of a naming rule table;

FIG. 4 is a diagram showing an example of a component information table according to a first exemplary embodiment;

FIG. 5 is a diagram illustrating a configuration example of a main part of an electric system in the server;

FIG. 6 is a flowchart illustrating an example of a flow of a document management process according to the first exemplary embodiment;

FIG. 7 is a diagram illustrating an example of a document name including a search text string;

FIG. 8 is a diagram illustrating an example of a document name decomposed into components;

FIG. 9 is a diagram illustrating an example of a search screen according to the first exemplary embodiment;

FIG. 10 is a flowchart illustrating an example of a flow of a document management process according to a second exemplary embodiment;

FIG. 11 is a diagram showing an example of a component information table according to the second exemplary embodiment;

FIG. 12 is a diagram illustrating an example of a search screen according to the second exemplary embodiment;

FIG. 13 is a diagram illustrating an example of a document name including a search text string used for describing Modification Example 1 of the second exemplary embodiment;

FIG. 14 is a diagram illustrating an example of a search screen in a case where Modification Example 1 of the second exemplary embodiment is not applied;

FIG. 15 is a diagram illustrating an example of a search screen in a case where Modification Example 1 of the second exemplary embodiment is applied;

FIG. 16 is a diagram illustrating an example of a document name including a search text string used for describing Modification Example 2 of the second exemplary embodiment;

FIG. 17 is a diagram illustrating an example of a component information table according to Modification Example 2 of the second exemplary embodiment;

FIG. 18 is a diagram illustrating an example of a conversion table; and

FIG. 19 is a diagram illustrating an example of a search screen in a case where Modification Example 2 of the second exemplary embodiment is applied.

### DETAILED DESCRIPTION

Hereinafter, an exemplary embodiment of the present invention will be described in detail with reference to the accompanying drawings. The identical components and the identical processes are denoted by the identical reference symbols throughout the drawings, and redundant description will be omitted.

### First Exemplary Embodiment

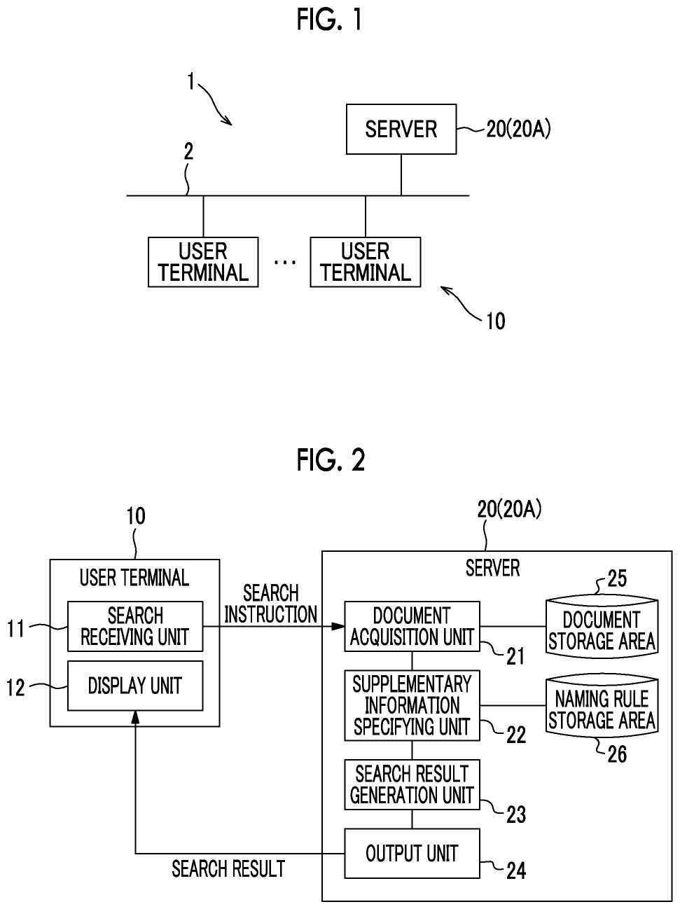

FIG. 1 is a diagram illustrating a configuration example of a document management system 1 according to a first exemplary embodiment. As illustrated in FIG. 1, the document management system 1 includes a user terminal 10 and a server 20, and the user terminal 10 and the server 20 are connected to a communication line 2.

The user terminal 10 is an information device operated by the user, and has a document search function. A document is a set of data representing a specific contents, and is managed as a file conforming to a predetermined data format. There is no restriction on the contents of the document managed by the document management system 1, and a document name (also referred to as a “file name”), which is an example of an identifier for identifying the document, is set in advance in each document.

By using the search function of the user terminal 10, the user designates a text string that is considered to be included in the document name of the document wanted by the user, and from among a plurality of documents managed by the server 20 described later, searches for documents including the designated text string in the document name. The user finds the wanted document while referring to the document name of the document included in the search result and determining whether or not the search result includes the document wanted by the user.

Hereinafter, a document wanted by the user is referred to as a “target document”, and a text string used for searching for the document is referred to as a “search text string”. The target document is an example of a document to be targeted according to the present exemplary embodiment, and the search text string is an example of a designated text string according to the present exemplary embodiment.

There is no restriction on the number of user terminals 10 included in the document management system 1, and at least one user terminal 10 is included in the document management system 1.

The server 20 is an example of a document management apparatus that manages a plurality of documents, and transmits to the user terminal 10, the document name of the document that includes in the document name, the search text string included in the search instruction received from the user terminal 10 as a search result.

There is no restriction on the communication protocol used in the communication line 2 to which the user terminal 10 and the server 20 are connected. The communication line 2 may be a wired line or a wireless line, or may be a line in which a wired line and a wireless line are mixed. Further, the communication line 2 may be a dedicated line or a public line such as the Internet that is shared by an unspecified number of users.

FIG. 2 is a diagram illustrating an example of the functional configuration of each of the user terminal 10 and the server 20. As illustrated in FIG. 2, the user terminal 10 includes a search receiving unit 11 and a display unit 12.

In a case of receiving the search text string from the user, the search receiving unit 11 generates a search instruction including the search text string, and transmits the generated search instruction to the document acquisition unit 21 of the server 20 via the communication line 2.

The display unit 12 displays a search result for the search instruction received from the server 20.

On the other hand, the server 20 includes the function units such as a document acquisition unit 21, a supplementary information specifying unit 22, a search result generation unit 23, and an output unit 24, and storage areas such as a document storage area 25 and a naming rule storage area 26.

The document acquisition unit 21 receives a search instruction from the user terminal 10, and acquires, from the documents stored in the document storage area 25, document names of documents including the search text string designated by the search instruction in the document names.

The supplementary information specifying unit 22 determines whether or not there is a document name configured according to the naming rule used in a document generation apparatus that automatically assigns a document name, among the document names acquired by the document acquisition unit 21, and specifies the meaning of the component including the search text string as supplementary information, in a case where there is a document name configured according to the naming rule.

The naming rule is, for example, a rule for naming a document used by a document generation apparatus that automatically assigns a document name of a generated document, such as a facsimile machine that generates a document in which received facsimile data is filed, or a scanner machine that optically reads the contents of a document and generates a filed document.

The component of the document name is an element constituting the document name, and is a minimum unit representing some meaning in the document name.

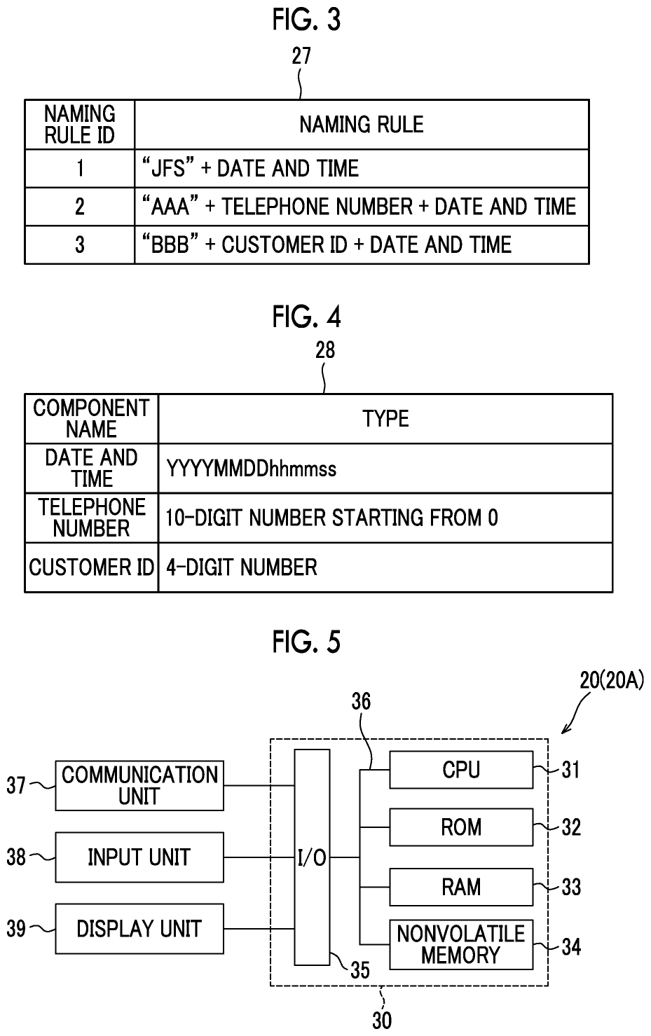

For example, the naming rule storage area 26 stores a naming rule table 27 as illustrated in FIG. 3. The naming rule identification (ID) in the naming rule table 27 is an identifier for managing a naming rule, and the naming rule is associated with each naming rule ID.

In the example of the naming rule table 27 illustrated in FIG. 3, the naming rule represented by the naming rule ID “1” is associated with the naming rule ““JFS”+date and time”. “JFS” is a fixed text string assigned to the document name as a prefix, and represents the type of the document. The date and time indicates the date and time when the document name is generated. The naming rule having the naming rule ID represented by “2” is associated with a naming rule of ““AAA”+telephone number+date and time”. “AAA” indicates the type of the document, and the telephone number indicates the telephone number associated with the document. The telephone number associated with the document is, for example, a facsimile number of the other party who has transmitted facsimile data, in a facsimile machine. The naming rule having the naming rule ID represented by “3” is associated with a naming rule of ““BBB”+customer ID+date and time”. “BBB” indicates the type of document.

In such a naming rule, each contents separated by “+” represents a component of the document name. That is, in a case of the naming rule having the naming rule ID “1”, “JFS” and the date and time are components of the document name. In a case of the naming rule having the naming rule ID “2”, “AAA”, the telephone number, and the date and time are components of the document name. In a case of the naming rule having the naming rule ID “3”, “BBB”, the customer ID, and the date and time are components of the document name.

Further, the naming rule storage area 26 stores a component information table 28 which defines how each component included in the naming rule table 27 is expressed.

FIG. 4 is a diagram illustrating an example of the component information table 28. In the component information table 28, the display format of the component of the document name used in the naming rule is defined as “type”. In the example of the component information table 28 illustrated in FIG. 4, the types of the date and time, the telephone number, and the customer ID type, which are components of the document name described in the naming rule table 27 illustrated in FIG. 3, are defined.

For example, it is defined that the date and time is represented by a 14-digit number such as “YYYYMMDDhhmmss”. “YYYY” represents the year (4 digits), “MM” represents the month (2 digits), “DD” represents the day (2 digits), “hh” represents the hour (2 digits), “mm” represents the minute (2 digits), and “ss” represents seconds (two digits). Further, it is defined that the telephone number is represented by a 10-digit number whose leading numeral starts from 0, and that the customer ID is represented by a 4-digit number.

As described above, in the naming rule storage area 26, the naming rules are managed which are used by each of the document generation apparatuses by which generated documents are stored in the document storage area 25, and which automatically assigns a document name in a case where a document is generated.

Therefore, the supplementary information specifying unit 22 refers to the naming rule table 27 and the component information table 28, and specifies the meaning of the component as supplementary information of the document name, in a case where there is a document name configured according to the naming rule defined in the naming rule table 27, among the document names acquired by the document acquisition unit 21.

For example, in a case where the search text string is “915” and the component including the search text string represents a telephone number, the supplementary information specifying unit 22 associates the search text string with the meaning of a telephone number.

The search result generation unit 23 generates a list of the document names acquired by the document acquisition unit 21, and with respect to the document name specified by the supplementary information by the supplementary information specifying unit 22, generates a search result reflecting the supplementary information in the document name such that the meaning of the supplementary information can be understood. A method of reflecting the supplementary information in the search result will be described in detail below. “Reflecting the supplementary information in the document name such that the meaning of the supplementary information can be understood” is to display the document name such that the user can understand which meaning of the component is described by the search text string. For example, in addition to the form in which the meaning of the supplementary information is indicated to the user by texts, a suggestion using a non-verbal method that reminds the user of the meaning of supplementary information by using figures, or the like, without using texts is an example of reflecting the supplementary information in the document name such that the meaning of the supplementary information can be understood.

The output unit 24 outputs the search result generated by the search result generation unit 23 to the user terminal 10 that has issued the search instruction. Thus, the display unit 12 of the user terminal 10 displays the search result received from the server 20, and the user is notified of the search result for the search text string.

Next, a configuration example of a main part of an electric system in the server 20 will be described.

FIG. 5 is a diagram illustrating a configuration example of a main part of an electric system in the server 20. The server 20 is configured using a computer 30, for example.

The computer 30 includes a central processing unit (CPU) 31, which is an example of a processor that executes a predetermined process of the server 20 according to the document management program, a read only memory (ROM) 32 that stores the document management program that causes the computer 30 to function as the server 20, a random access memory (RAM) 33 used as a temporary work area of the CPU 31, a nonvolatile memory 34, and an input/output interface (I/O) 35. Then, the CPU 31, the ROM 32, the RAM 33, the non-volatile memory 34, and the I/O 35 are connected to each other via a bus 36.

The nonvolatile memory 34 is an example of a storage device that retains stored information even in a case where power supplied to the nonvolatile memory 34 is cut off., and for example, a semiconductor memory is used, but a hard disk may be used. The document storage area 25 and the naming rule storage area 26 need not necessarily be constructed in the nonvolatile memory 34, and may be constructed in an external apparatus (not illustrated) connected to the communication line 2 such as a cloud server, for example. Hereinafter, as an example, it is assumed that the document storage area 25 and the naming rule storage area 26 are constructed in the nonvolatile memory 34.

For example, a communication unit 37, an input unit 38, and a display unit 39 are connected to the I/O 35.

The communication unit 37 is connected to the communication line 2 and has a communication protocol for performing data communication with the user terminal 10 and the external apparatus (not illustrated).

The input unit 38 is a device that receives a user's instruction and notifies the CPU 31 of the instruction. For example, a button, a touch panel, a keyboard, a mouse, or the like is used. In a case of receiving an instruction by voice, a microphone may be used as the input unit 38.

The display unit 39 is an example of a device that visually displays information processed by the CPU 31, and for example, a liquid crystal display, an organic electro luminescence (EL) display, or the like is used.

The unit connected to the I/O 35 is an example, and it goes without saying that a unit other than the unit illustrated in FIG. 5 may be connected as needed.

Note that the user terminal 10 is also realized by the computer 30 having the same configuration as that of the configuration example of the main part of the electric system in the server 20 illustrated in FIG. 5. However, in the case of the computer 30 constituting the user terminal 10, the ROM 32 stores a user terminal program that causes the computer 30 to function as the user terminal 10.

Next, the operation of the document management process in the server 20 will be described.

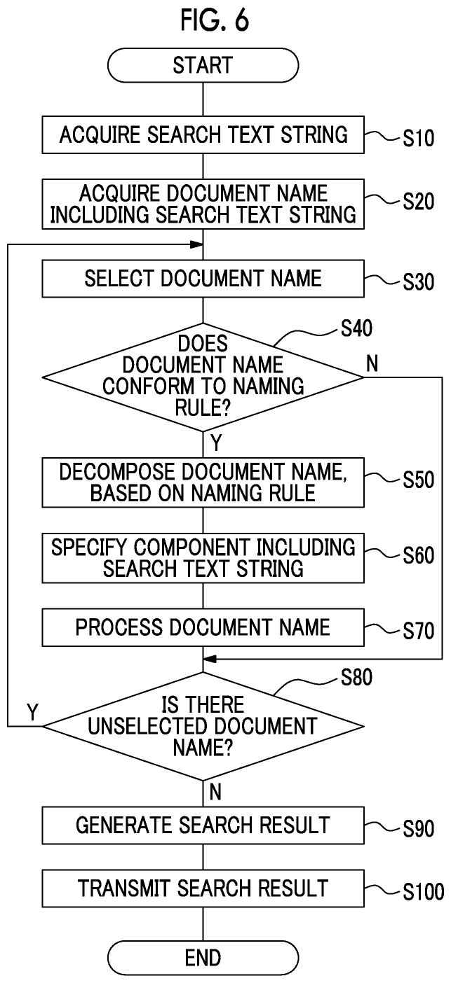

FIG. 6 is a flowchart illustrating an example of the flow of a document management process executed by the CPU 31 of the server 20 in a case where a search instruction is received from the user terminal 10. The document management program that defines the document management process is stored in advance in the ROM 32 of the server 20, for example. The CPU 31 of the server 20 reads the document management program stored in the ROM 32 and executes the document management process.

In step S10, the CPU 31 acquires a search text string included in the search instruction received from the user terminal 10.

In step S20, the CPU 31 acquires, from the documents stored in the document storage area 25, the document name of the document including the search text string acquired instep S10 in the document name.

In step S30, the CPU 31 selects any one document name not yet selected from the document names acquired in step S20. For convenience of explanation, the document name selected in step S30 is referred to as “selected document name”.

In step S40, the CPU 31 refers to the naming rule table 27 and the component information table 28 to determine whether or not the selected document name is configured according to any one of the naming rules defined in the naming rule table 27.

In a case where the selected document name is configured according to any of the naming rules, the selected document name is not a document name assigned by a person in consideration of the document contents but a document name automatically assigned by the document generation apparatus. In other words, the selected document name is assigned a document name from which it is difficult to understand the meaning at first glance, such as a string of at least one of numbers, texts, or symbols according to the naming rules.

Therefore, in a case where the selected document name is configured according to any one of the naming rules defined in the naming rule table 27, the process proceeds to step S50, it is specified that the search text string is used as a text string representing which meaning, in the selected document name such that the user can easily determine whether or not the document including the search text string in the document name is the target document.

Therefore, in step S50, the CPU 31 decomposes the selected document name into component units, with reference to the naming rule table 27 and the component information table 28. For example, in a case where the selected document name is “JFS20181219134409.xdw”, the document name is configured according to the naming rule with the naming rule ID “1” illustrated in FIG. 3, so that the selected document name is decomposed into components of “JFS”, “20181219134409”, and “.xdw”. Note that a text string of four or more texts starting from “.” placed at the end of the document name is an extension indicating the data format of the document, and is included in any document name, so the description of the text string is omitted in the naming rule table 27.

In step S60, the CPU 31 specifies a component including the search text string, from among the components decomposed in step S50. For example, in a case where the search text string is “201812”, “201812” in the document name of “JFS20181219134409.xdw” is a part of the text string representing the date and time, so the search text string is a part of the text string representing the date and time.

In step S70, the CPU 31 processes the display form of the selected document name such that supplementary information indicating the meaning of the component including the search text string specified in step S60 in the selected document name is transmitted to the user. For example, the CPU 31 processes the display form of the selected document name such that the display form of the selected document name differs between the text string representing the contents of the component including the search text string and the text string representing the contents of the component not including the search text string, such as underlining only the text string representing the contents of the component including the search text string, among the components constituting the selected document name. Thus, the text string including the search text string is divided into meaningful minimum unit text strings, and the range is represented in the document name.

On the other hand, in a case where it is determined in the determination process in step S40 that the selected document name does not comply with any naming rule, it means that the selected document name is not a document name automatically assigned by the document generation apparatus. In this case, since the selected document name is considered to be a document name assigned by a person in consideration of the document contents, the contents of the document is inferred from the selected document name, without processing the display form of the selected document name.

Therefore, the process proceeds to step S80 without executing steps S50 to S70.

In step S80, the CPU 31 determines whether or not there is an unselected document name that has not been selected in step S30, among the document names acquired in step S20. In a case where there is an unselected document name, the process proceeds to step S30, and any one of the unselected document names is selected as a new selected document name. In the determination process of step S80, by repeatedly executing steps S30 to S80 until it is determined that all the document names acquired in step S20 have been selected, the specified supplementary information is reflected in the document name of each document in which the document name is automatically assigned according to the naming rules, among the documents whose search text string is included in the document name.

In a case where it is determined in the determination process of step S80 that all the document names acquired in step S20 have been selected, the process proceeds to step S90.

In step S90, the CPU 31 generates a search result including each of the document names acquired in step S20. For the document name that has been processed into the display form in step S70, the document name reflecting the supplementary information is included in the search result.

In step S100, the CPU 31 controls the communication unit 37 to transmit the search result generated in step S90 to the user terminal 10, which is the transmission source of the search instruction, and ends the document management process illustrated in FIG. 6.

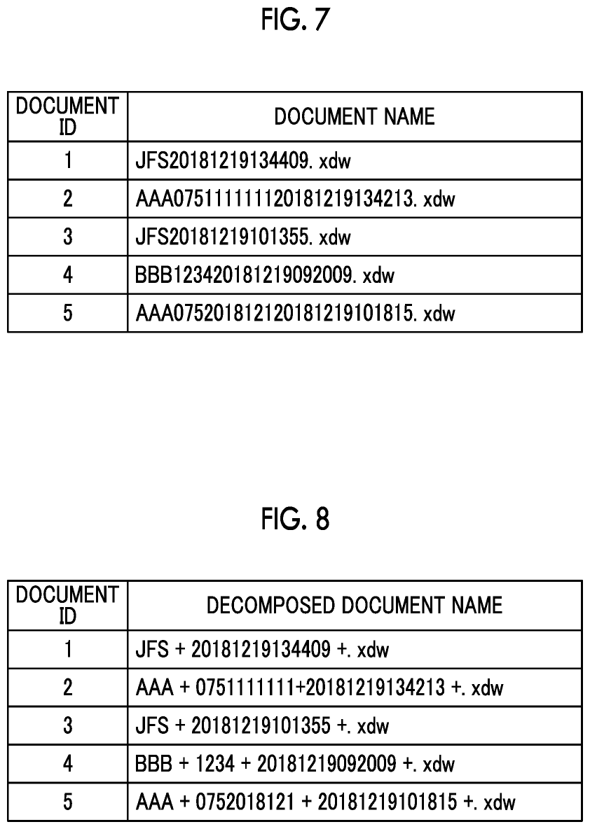

FIG. 7 is a diagram illustrating an example of document names including the text string “201812”, acquired in step S20 in FIG. 6, in a case where a search instruction including the search text string “201812” is received from the user terminal 10.

The document names represented by the document IDs “1” to “5” are configured according to the naming rules defined in the naming rule table 27 illustrated in FIG. 3. Specifically, the document names represented by the document IDs “1” and “3” are configured according to the naming rule represented by the naming rule ID “1”, the document names represented by the document IDs “2” and “5” are configured according to the naming rule represented by the naming rule ID “2”, and the document name represented by the document ID “4” is configured according to the naming rule represented by the naming rule ID “3”.

Therefore, in step S50 in FIG. 6, each document name is decomposed into component units as illustrated in FIG. 8.

In document names whose document IDs are represented by “1” to “4”, each search text string is used for a component representing the meaning of date and time. In a document name whose document ID is represented by “5”, the search text string is used for components representing a date and time and a telephone number. Therefore, in step S70, the process of underlining the entire text string representing the date and time is performed on each of the document names represented by the document IDs “1” to “4”, and the process of underlining the entire text strings respectively representing the date and time and the telephone number is performed on the document names represented by the document ID “5”.

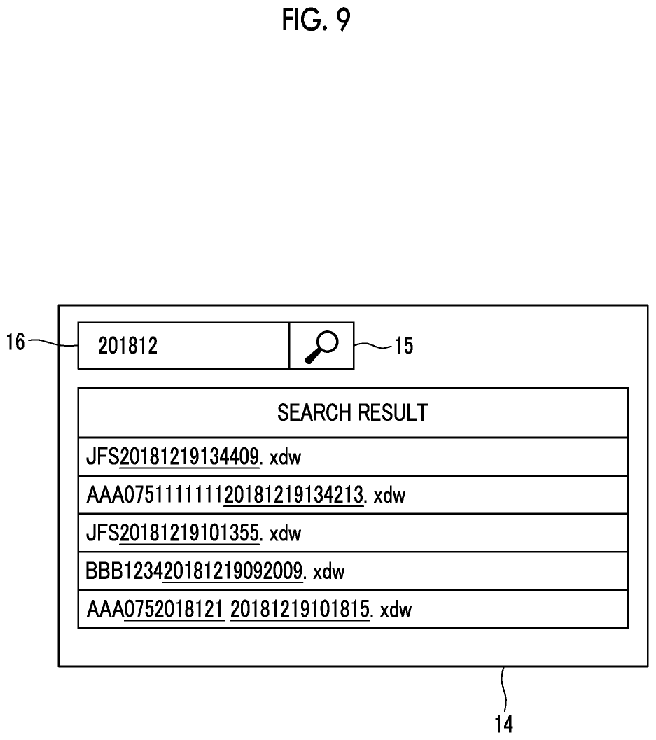

FIG. 9 is a diagram illustrating an example of the search screen 14 displayed on the user terminal 10 that has transmitted the search instruction including the search text string “201812” to the server 20. By the user inputting a search text string in the input field 16 and pressing the search button 15 with a mouse or the like, the document management process illustrated in FIG. 6 is executed by the server 20, and a list of document names including the search text string is displayed as the search result on the search screen 14.

As a result of the above-described process of the document name, the document name in which the text string including “201812” in component units is underlined is displayed on the search screen 14.

In step S70 in FIG. 6, the range of the text string representing the contents of the component including the search text string is underlined such that the meaning of the component including the search text string is transmitted to the user, but the display form of the text string representing the contents of the component including the search text string is not limited to this. For example, with respect to the text string representing the contents of the component including the search text string, at least one of the attributes of the text string representing characteristics of the text string, such as the font of the text string, the size of the text string, the inclination of the text string, the thickness of the text string, and the color of the text string may be different from a text string representing the contents of a component that does not include the search text string. For example, the display forms of a text string representing the contents of a component including the search text string and a text string representing the contents of a component that does not include the search text string may be changed, depending on the presence or absence of decoration of the text strings that shade or add dots to the text strings.

In addition, in step S100, the form in which the server 20 transmits the search result to the user terminal 10 through the communication line 2 has been described, but in addition to the form in which the search result is transmitted to another device through the communication line 2, the form in which the search result is displayed on the display unit 39, the form in which the search result is notified by voice, and the form in which the search result is printed on a recording medium such as paper can also make the user recognize the search result, so these forms are also an example of the form of outputting a search result.

As described above, according to the server 20 according to the first exemplary embodiment, the component including the search text string is specified from the document name of the document of which the document name is automatically assigned, and the text string representing the contents of the specified component is displayed in a display form different from a text string representing the contents of another component. Therefore, the user can easily understand the meaning of the search text string in the document name, as compared with a case where the text string matching the search text string is simply displayed in a display form different from other text strings. Even in a case of the document of which document name is automatically assigned, the user can easily determine whether the document is the target document from the document name.

### Second Exemplary Embodiment

The server 20 according to the first exemplary embodiment clearly indicates the meaning of the component including the search text string, that is, the supplementary information, by changing the display form of the document name, but in the second exemplary embodiment, a server 20A which clearly indicates the meaning of the component including the search text string by writing the supplementary information along with the document name will be described.

Since the configuration example of the document management system 1 including the server 20A according to the second exemplary embodiment, the functional configuration example of the server 20A, and the configuration example of the main part of the electric system in the server 20A are identical to the configurations illustrated in FIGS. 1, 2, and 5, the description is omitted.

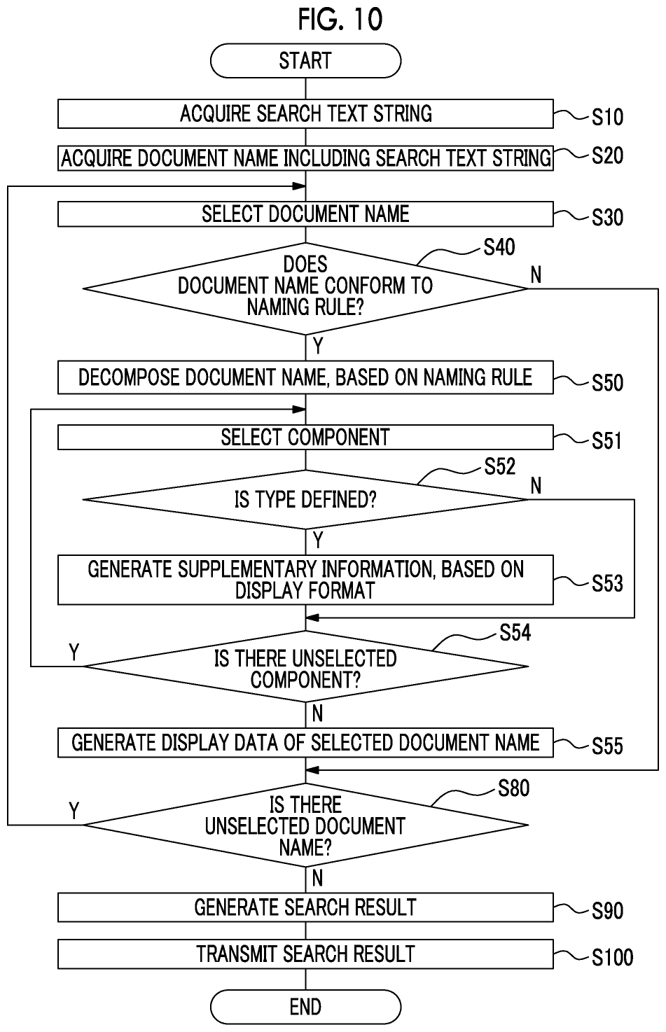

FIG. 10 is a flowchart illustrating an example of the flow of a document management process executed by the CPU 31 of the server 20A in a case where a search instruction is received from the user terminal 10. The document management program that defines the document management process is stored in advance in the ROM 32 of the server 20A, for example. The CPU 31 of the server 20A reads the document management program stored in the ROM 32 and executes the document management process.

The flowchart illustrated in FIG. 10 differs from the flowchart of the document management process according to the first exemplary embodiment illustrated in FIG. 6 in that steps S60 and S70 are replaced with steps S51 to S55, and the other processes are the same. Therefore, hereinafter, the document management process of the server 20A according to the second exemplary embodiment will be described focusing on the process of steps S51 to S55.

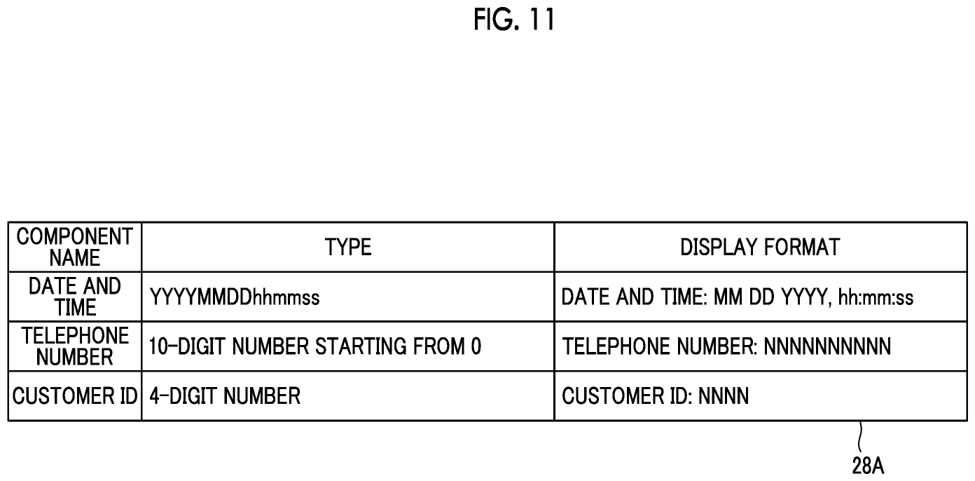

In the second exemplary embodiment, a component information table 28A as illustrated in FIG. 11 is used instead of the component information table 28 illustrated in FIG. 4. A display format field not included in the component information table 28 is added to the component information table 28A.

In the display format field of the component information table 28A, a model of a display format used in a case of displaying each component in a search result is defined. For example, in a case where the component is a date and time, the date and time in the document name is represented as “YYYYMMDDhhmmss”, but it is defined that the date and time is displayed as “Date and time: MM DD, YYYY hh:mm:ss” in the search result. Similarly, for each component of the telephone number and the customer ID, a model of a display format used in a case of displaying the component in the search result is defined. Note that “N” in the display formats of the telephone number and the customer ID represents any one number from “0” to “9”.

After the selected document name is decomposed into component units in step S50, step S51 is executed.

In step S51, the CPU 31 selects any one component not yet selected, from among the components of the selected document name decomposed in step S50. For convenience of explanation, the component selected in step S51 is referred to as “selected component”.

In step S52, the CPU 31 determines whether or not the type of the selected component is defined in the component information table 28A. In the case of the example of the component information table 28A illustrated in FIG. 11, since the types for the components of the date and time, the telephone number, and the customer ID are defined, in a case where the selected component is any one of the date and time, the telephone number, and the customer ID, the type of the selected component is defined in the component information table 28A, and the process proceeds to step S53.

In step S53, the CPU 31 refers to the display format of the component information table 28A, and generates a text string representing the contents of the selected component based on the display format defined for the selected component. Since the generated text string represents the meaning of the components constituting the selected document name, the generated text string is an example of supplementary information.

On the other hand, in a case where it is determined in the determination process of step S52 that the type of the selected component is not defined in the component information table 28A, the process proceeds to step S54 without executing the process of step S53. For example, since the component “JFS” representing the type of the document is not registered in the component information table 28A illustrated in FIG. 11, the CPU 31 does not generate supplementary information for “JFS” in step S53.

In step S54, the CPU 31 determines whether or not there is an unselected component that has not been selected in step S51, among the components of the selected document name decomposed in step S50.

In a case where there is an unselected component, the process proceeds to step S51, and any one of the unselected components is selected as a new selected component. In the determination process of step S54, by repeatedly executing steps S51 to S54 until it is determined that all the components of the selected document name decomposed in step S50 have been selected, with respect to each component whose type is defined in the component information table 28A, among the components of the selected document name, a text string representing the contents of the component is generated based on the display format of the component information table 28.

In a case where it is determined in the determination process of step S54 that all components of the selected document name decomposed in step S50 have been selected, the process proceeds to step S55.

In step S55, the CPU 31 generates display data of the selected document name in which the selected document name is associated with a text string representing the contents of each component constituting the selected document name.

For example, instep S20, in a case where a document name including the search text string of “201812” as illustrated in FIG. 7 is acquired, for “JFS20181219134409.xdw” represented by the document ID “1”, display data including supplementary information indicating the meaning of “20181219134409” such as “JFS20181219134409.xdw Date and time: Dec. 19, 2018, 13:44:09” is generated.

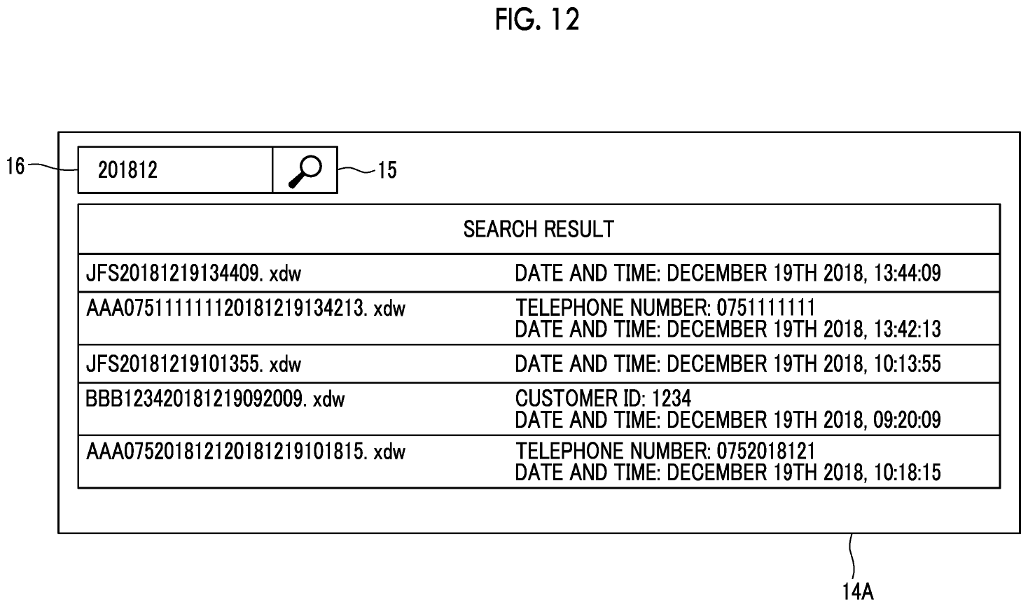

Therefore, as illustrated in FIG. 12, the user terminal 10 displays a search screen 14A in which the text strings representing the contents of not only the component including the search text string but also the component not including the search text string are written along with the searched document name, based on the corresponding display format. Thus, even in a case of a document of which document name is automatically assigned, the meanings of the components constituting the document name are notified to the user. As a matter of course, the CPU 31 may generate a search result such that only the text strings representing the contents of the component including the search text string is displayed together with the searched document name on the search screen 14A, based on the corresponding display format.

As described above, writing the supplementary information along with the document name is to display a text string other than the document name on the search screen 14A as the supplementary information of the document name. There is no restriction on the display positions of the document name and the supplementary information on the search screen 14A, and the document name and the supplementary information may be displayed such that the correspondence between the document name and the supplementary information can be understood. In a case where the correspondence between the document name and the supplementary information is displayed so as to be understood, the supplementary information does not necessarily need to be displayed in the same page as the corresponding document name. For example, in a case where a document name is clicked with a mouse or the like, a form in which a page describing supplementary information of the clicked document name is displayed is also an example of a form in which the supplementary information is written along with the document name.

Modification Example 1 of Second Exemplary Embodiment

Since the meaning of the component constituting the searched document name is displayed on the search screen 14A as supplementary information of the document name, as compared with the case where the supplementary information is not displayed, the user can easily determine whether or not the document is the target document, from the document name of the searched document. However, even in a case where the meaning is displayed on the search screen 14A, there may be supplementary information that is difficult to use as a determination material for finding the target document.

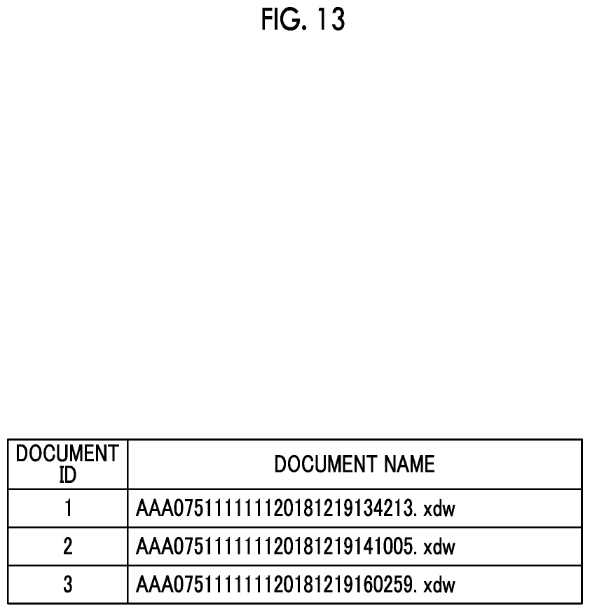

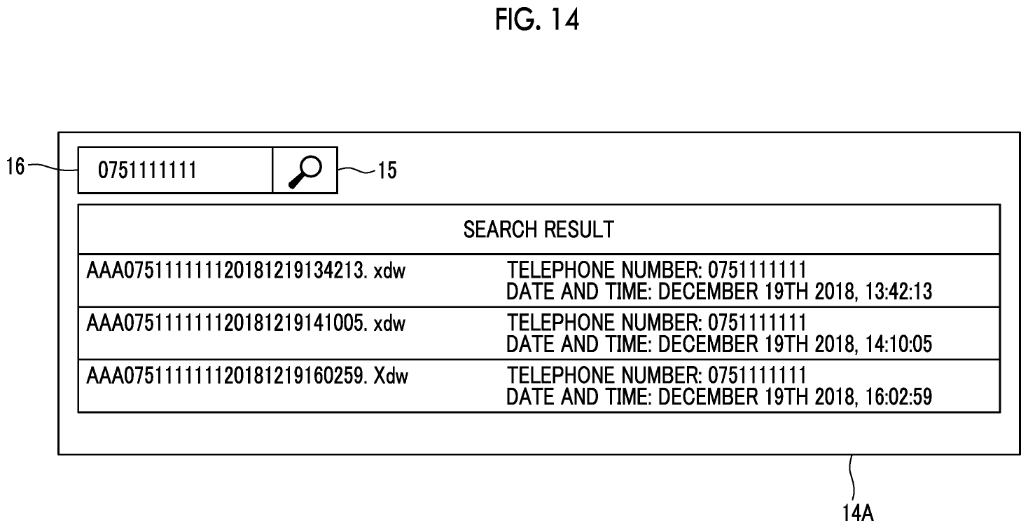

For example, it is assumed that a document name including a search text string of “0751111111” as illustrated in FIG. 13 is acquired in step S20 in FIG. 10. In this case, in a case where the document management process illustrated in FIG. 10 is executed in the server 20A, each of the acquired document names includes the components of the telephone number and the date and time, so that for example, as illustrated in FIG. 14, supplementary information representing the telephone number and the date and time is displayed for each document name, on the search screen 14A.

However, since the destination of the same telephone number “0751111111” is associated with each of the acquired document names, it is difficult for the user to recognize the difference in the contents of documents from the telephone number. In other words, even in a case where a telephone number is written along with the document name as supplementary information, the telephone number is less valuable as a determination material for finding the target document than other types of supplementary information with differences in contents.

Therefore, in a case of generating the search result in step S90 of FIG. 10, in a case where any one of the components constituting the document name of each document including the search text string represents the same contents in each document name, the CPU 31 generates a search result such that the meaning of the component representing the same contents is not used as supplementary information of the document name.

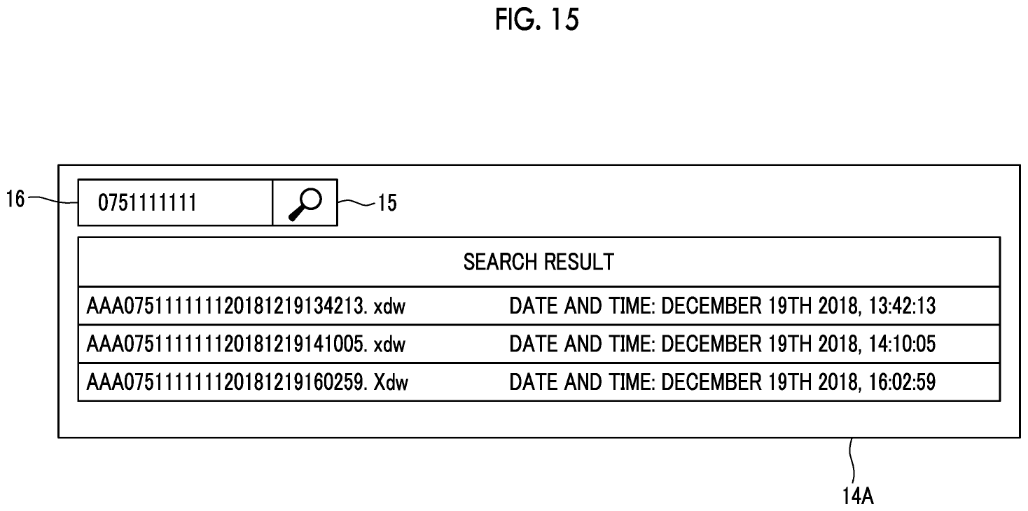

FIG. 15 is a diagram illustrating an example of the search screen 14A which displays the search result processed not to display the supplementary information of the component representing the same contents, in a case where a document name including the search text string of “0751111111” as illustrated in FIG. 13 is acquired, in step S20 of FIG. 10. In this case, different from the search screen 14A illustrated in FIG. 14, the supplementary information of “telephone number: 0751111111” is not displayed on the search screen 14A.

Modification Example 2 of Second Exemplary Embodiment

The server 20A specifies the meanings represented by the text strings constituting the document name in component units, and writes the text string representing the contents of the component along with the document name in an expression based on the display format. In a case where the component is a telephone number, as described above, the supplementary information about the telephone number may be displayed as “telephone number: 0751111111”, but sometimes it is difficult to remember whose telephone number this is from a string of numbers “0751111111”.

Therefore, for example, in the case where a text string representing some meaning, such as a telephone number or an e-mail address, is a component composed of a string of at least one of numbers, texts, or symbols, it is preferable to notify the user of correspondence information associated with the text string representing the contents of the component, such as who the telephone number or e-mail address represents, instead of the text string representing the contents of the component used in the document name.

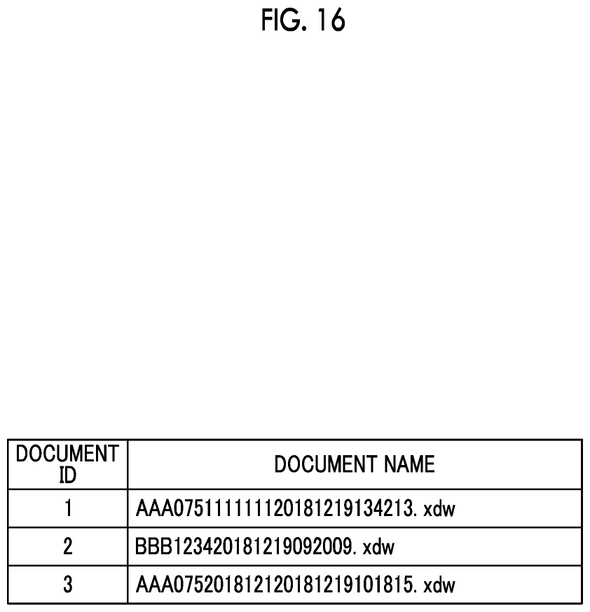

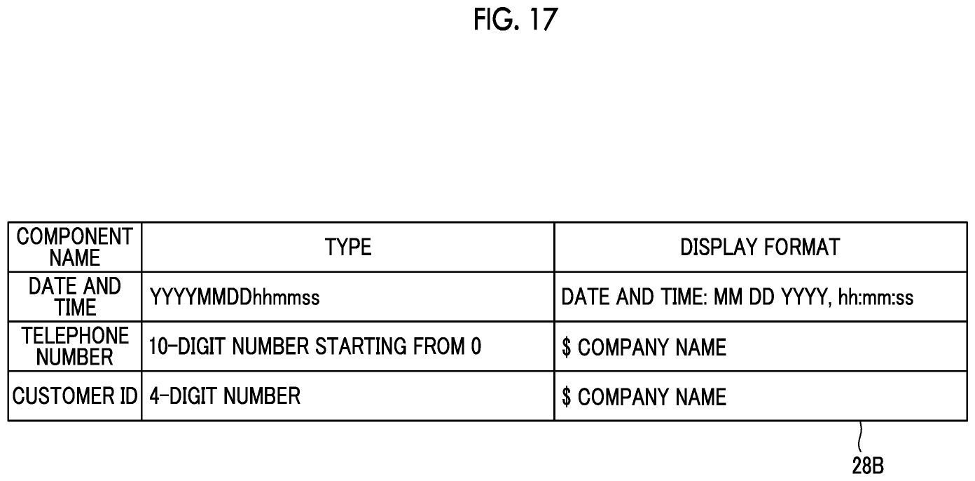

For example, it is assumed that a document name including a search text string of “201812” as illustrated in FIG. 16 is acquired in step S20 in FIG. 10. In this case, it is assumed that the component information table 28B as illustrated in FIG. 17 is used.

In the component information table 28B illustrated in FIG. 17, with respect to “$company name” of which components are defined in the display format fields of the telephone number and the customer ID, text strings representing the telephone number and the customer ID used in the document name are converted into correspondence information associated with the item “company name” and displayed.

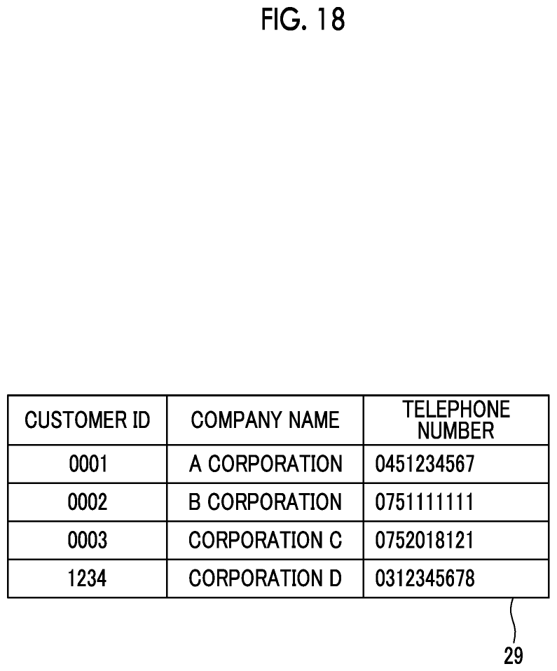

FIG. 18 is a diagram illustrating an example of a conversion table 29 used to convert a text string representing the contents of a component used in a document name into correspondence information. In the example of the conversion table 29 illustrated in FIG. 18, a customer ID and a telephone number are included as components constituting the document name, and correspondence information of “company name” is associated with each component. For example, a company name “B Corporation” is associated with a text string whose customer ID is “0002” or whose telephone number is “0751111111”.

Therefore, in a case where the CPU 31 generates the text string representing the contents of the selected component based on the display format defined for the selected component in step S53 of FIG. 10, the selected component is a telephone number. In a case where the text string representing the telephone number is “0751111111”, the text string of “B Corporation”, which is the company name corresponding to the telephone number of “0751111111”, is acquired with reference to the conversion table 29 illustrated in FIG. 18. Then, the CPU 31 generates supplementary information of the document name in which the telephone number acquired from the selected document name is replaced with “B Corporation” which is the name of the company of the other party who has called.

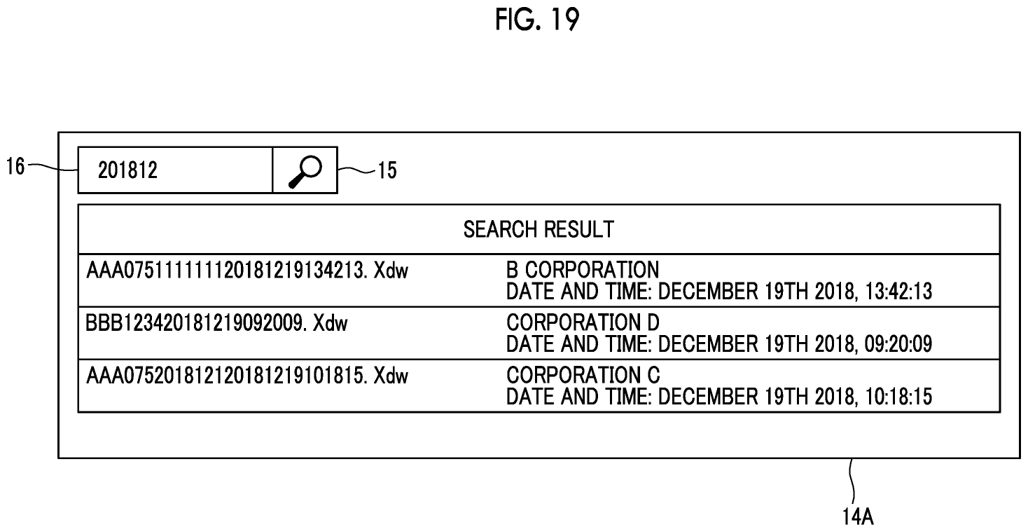

FIG. 19 is a diagram illustrating an example of the search screen 14A displayed on the user terminal 10, in a case where a text string representing the contents of a component whose correspondence information is defined in the conversion table 29 illustrated in FIG. 18 is replaced with the correspondence information, for a document name including the search text string “201812” as illustrated in FIG. 16.

In the first line of the search result on the search screen 14A, “0751111111” representing the telephone number is replaced with “B Corporation”, and in the second line, “1234” representing the customer ID is replaced with “D Corporation”, and in the third line, “0752018121” representing the telephone number is replaced with “C Corporation”.

The CPU 31 does not necessarily need to refer to the conversion table 29, in a case of converting a text string representing the contents of a component into correspondence information. For example, the CPU 31 may acquire correspondence information corresponding to a text string representing the contents of a component from information published on the Internet (for example, an electronic phonebook in which a telephone number is associated with a destination name), by using a search application stored in the ROM 32 in advance.

As described above, the server 20A according to the second exemplary embodiment clearly indicates the meanings of the components constituting the document name, by writing the supplementary information of the document name along with the document name, in addition to the document name, instead of processing the document name.

Although the present invention has been described with reference to exemplary embodiments, the present invention is not limited to the scope described in exemplary embodiments. Various modifications or improvements can be added to exemplary embodiments within the scope without departing from the gist of the present invention, and modified or improved aspects are also included in the technical scope of the present invention. For example, the order of processes may be changed without departing from the spirit of the present invention.

In the exemplary embodiments, the facsimile machine and the scanner machine are exemplified as the document generation apparatuses that automatically assign the document names of the generated documents. However, a camera that assigns a file name to captured image data is also an example of the automatic generation apparatus. Information device in which an application for automatically assigning a file name according to a predetermined naming rule in a case where a user assigns an instruction to save data without designating a file name is also an example of the document generation apparatus.

Further, in the exemplary embodiments, the server 20 and the server 20A that receive a search text string from the user terminal 10, generate a search result in which the meanings of the components constituting the document name are clearly indicated in a list of document names including the search text string, and transmit the generated search result to the user terminal 10 have been described. However, the server 20 and the server 20A may receive the search text string not from the user terminal 10 but from the input unit 38 of the server 20 and the server 20A, respectively, and display the search screen 14 and the search screen 14A including the search result on the display unit 39 of the server 20 and the server 20A. In this case, since the user operates the server 20 and the server 20A, the document management system 1 does not require the user terminal 10. As a matter of course, the user terminal 10 may execute the document management process illustrated in FIGS. 6 and 10. In this case, the document management system 1 does not require the server 20 and the server 20A.

Further, in the exemplary embodiments, an example has been described in which the document management process is implemented by software. However, the process equivalent to the flowcharts illustrated in FIGS. 6 and 10 may be mounted on, for example, an application specific integrated circuit (ASIC), a field programmable gate array (FPGA), or a programmable logic device (PLD) and processed by hardware. In this case, the processing speed is increased as compared with the case where each process is implemented by software.

As described above, the CPU 31 of the server 20 and the server 20A may be replaced with a dedicated processor specialized for a specific process such as an ASIC, an FPGA, a PLD, a Graphics Processing Unit (GPU), and a Floating Point Unit (FPU).

The operation of the CPU 31 of the server 20 and the server 20A in the exemplary embodiments may be implemented by a plurality of CPUs 31 in addition to the aspect in which the operation is implemented by one CPU 31. Further, the operation of the CPU 31 of the server 20 and the server 20A in the exemplary embodiments may be implemented by cooperation of the CPU 31 of the computer 30 located at a physically distant position.

Further, in the above-described exemplary embodiments, the aspect in which the document management program is installed in the ROM 32 has been described, but the present invention is not limited to this. The document management program according to the exemplary embodiments may be provided in a form recorded on a computer-readable storage medium. For example, the document management program may be provided in a form recorded on an optical disc such as a compact disc (CD)-ROM or a digital versatile disc (DVD)-ROM. Further, the document management program according to the exemplary embodiments may be provided in a form recorded in a portable semiconductor memory such as a universal serial bus (USB) memory or a memory card.

Further, the server 20 and the server 20A may acquire the document management program from an external apparatus connected to the communication line 2 via the communication unit 37.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A document management apparatus comprising:
a processor configured to
acquire a document name of a document including a designated text string;
in a case where the acquired document name is configured according to a naming rule used for automatic generation of a document name, specify meaning of a component including the designated text string and constituting the document name of the document, as supplementary information of the document name of the document, by using the naming rule; and
output the document name of the document such that meaning of the specified supplementary information is to be understood.

2. The document management apparatus according to claim 1,
wherein the processor is configured to output the meaning of the component including the designated text string by reflecting the supplementary information in a display form of the document name of the document.

3. The document management apparatus according to claim 2,
wherein the processor is configured to output the document name of the document such that a display form is different between a component including the designated text string and a component not including the designated text string, among components constituting the document name of the document.

4. The document management apparatus according to claim 1,
wherein the processor is configured to write the supplementary information along with the document name of the document.

5. The document management apparatus according to claim 4,
wherein the processor is configured to add meaning of a component not including the designated text string, among components constituting the document name of the document, to the supplementary information, and write the supplementary information along with the document name of the document.

6. The document management apparatus according to claim 5,
wherein the processor is configured not to use the meaning of the component representing the same contents as the supplementary information of the document name of the document in a case where any one of the components of the document name of the acquired document represents the same contents.

7. The document management apparatus according to claim 5,
wherein the processor is configured to, in a case where contents of a component constituting the document name of the document are represented by an identifier including at least one of a number, a text, or a symbol, replace the identifier with a name associated with the identifier, and write the supplementary information along with the document name of the document.

8. The document management apparatus according to claim 6,
wherein the processor is configured to, in a case where the contents of a component constituting the document name of the document is represented by an identifier including at least one of a number, a text, or a symbol, replace the identifier with a name associated with the identifier, and write the supplementary information along with the document name of the document.

9. A non-transitory computer readable medium storing a document management program causing a computer to execute a process, the process comprising:
acquiring a document name of a document including a designated text string;
in a case where the acquired document name is configured according to a naming rule used for automatic generation of a document name, specifying meaning of a component including the designated text string and constituting the document name of the document, as supplementary information of the document name of the document, by using the naming rule; and
outputting the document name of the document such that meaning of the specified supplementary information is to be understood.
